(19) United States
(12) Patent Application Publication
(10) Pub. No.: US 2025/0306557 A1
(43) Pub. Date: Oct. 2, 2025

(54) MOVING BODY CONTROL DEVICE, MOVING BODY CONTROL METHOD, AND STORAGE MEDIUM

(71) Applicant: HONDA MOTOR CO., LTD., Tokyo (JP)

(72) Inventors: Hisahiro Kato, Tokyo (JP); Hiroaki Hakukawa, Tokyo (JP); Takayuki Inomata, okyo (JP); Satoshi Aiyoshizawa, Tokyo (JP); Iori Muguruma, Tokyo (JP); Noriaki Ihori, Tokyo (JP); Noboru Ujigawa, Tokyo (JP)

(21) Appl. No.: 19/051,585

(22) Filed: Feb. 12, 2025

(30) Foreign Application Priority Data
Mar. 27, 2024 (JP) 2024-050798

(51) Int. Cl. G05B 19/042

(52) U.S. Cl. CPC G05B 19/0426; G05B 2219/24033

(57) ABSTRACT

A moving body control device includes a software update part that executes update processing for software of each of a plurality of device control units provided in a moving body, a device operation state recognition part that recognizes an operation state of each of operation devices controlled by the device control units, respectively, and a software update restriction part that executes software update prohibition processing of prohibiting the software update part from executing the update processing for the software of each of the device control units, while the operation devices are recognized as being in operation by the device operation state recognition part.

### INCORPORATION BY REFERENCE

The present application claims priority under 35 U.S.C. § 119 to Japanese Patent Application No. 2024-050798 filed on Mar. 27, 2024. The content of the application is incorporated herein by reference in its entirety.

### BACKGROUND OF THE INVENTION

### Field of the Invention

The present invention relates to a moving body control device, moving body control method, and storage medium.

### Description of the Related Art

Conventionally, techniques of supporting update of software of an in-vehicle device have been suggested. For example, Japanese Patent Laid-Open No. 2022-40990 discloses a technique of control to place a door of a vehicle into an unlocked state before executing update processing for software, to avoid the situation where the door becomes unable to unlock due to a restriction placed on the function of the vehicle during the software update of the in-vehicle device.

In addition, a moving body such as a vehicle is equipped with various devices operated in response to an operation of a user, and when update processing for software of a control device is executed while these devices are in operation, the operations of the devices may be interrupted, causing discomfort and anxiety to the user. To solve this problem, the present application is aimed at avoiding the interruption of the operations of the devices provided in the moving body due to the update processing for the software of the control device.

An object of the present application is to improve safety for solving the above problem, and consequently, to further improve traffic safety, contributing to the development of a sustainable transportation system.

### SUMMARY OF THE INVENTION

As a first aspect for achieving the above object, a moving body control device is provided, the moving body control device including a software update part that executes update processing for software of a device control unit provided in a moving body, a device operation state recognition part that recognizes an operation state of an operation device controlled by the device control unit, and a software update restriction part that executes software update prohibition processing of prohibiting the software update part from executing the update processing for the software of the device control unit, while the operation device is recognized as being in operation by the device operation state recognition part.

The moving body control device may include an integrated control unit connected to a plurality of device control units individually controlling a plurality of operation devices provided in the moving body and may be configured such that the software update part executes update processing for software of each of the plurality of device control units via the integrated control unit, the device operation state recognition part recognizes an operation state of each of the plurality of operation devices via the integrated control unit, and the software update restriction part executes the software update prohibition processing for the plurality of device control units via the integrated control unit.

The moving body control device may include a nearby-person recognition part that recognizes a person around the moving body and may be configured such that the software update restriction part ends the software update prohibition processing, and allows the software update part to execute the update processing for the software of the device control unit, when the device operation state recognition part recognizes that the operation of the operation device has ended and the person is not recognized by the nearby-person recognition part during the execution of the software update prohibition processing.

The moving body control device may include a communication control part that performs communication with a user terminal for use by a user of the moving body and may be configured as described below. The device control unit starts operating the operation device upon the communication control part receiving operation instruction information of the operation device that is transmitted from the user terminal. After starting the software update prohibition processing when the device control unit starts operating the operation device on receiving the operation instruction information and in response to the device operation state recognition part recognizing that the operation device is in operation, and when the device operation state recognition part recognizes completion of the operation of the operation device, the software update restriction part: causes the communication control part to transmit, to the user terminal, software update confirmation information inquiring whether to execute the update processing for the software of the device control unit; and upon the communication control part receiving software update instruction information transmitted from the user terminal, ends the software update prohibition processing to allow the software update part to execute the update processing for the software of the device control unit, the software update instruction information instructing the execution of the update processing for the software of the device control unit.

The moving body control device may include a communication control part that performs communication with a user terminal for use by a user of the moving body and may be configured as described below. The device control unit starts operating the operation device upon the communication control part receiving operation instruction information of the operation device that is transmitted from the user terminal. After starting the software update prohibition processing when the device control unit starts operating the operation device on receiving the operation instruction information and in response to the device operation state recognition part recognizing that the operation device is in operation, and when the device operation state recognition part recognizes completion of the operation of the operation device, the software update restriction part: receives, via the communication control part, detected information of an acceleration sensor provided in the moving body, to recognize whether the user terminal is stopped based on the detected information, the detected information being transmitted from the user terminal; and when it is recognized that the user terminal is stopped, ends the software update prohibition processing to allow the software update part to execute the update processing for the software of the device control unit.

In the moving body control device, the operation device may be configured to be any one of an opening/closing device of a door of the moving body, a locking device of the door of the moving body, a charge lid of the moving body, a fuel lid of the moving body, an electric sliding seat of the moving body, an opening/closing device of a trunk of the moving body, an opening/closing device of a tailgate of the moving body, a telescopic device of an air suspension of the moving body, an opening/closing device of a power window of the moving body, an opening/closing device of a sunroof of the moving body, an opening/closing device of a sunshade of the moving body, a tilt and telescopic adjustment device of a steering wheel of the moving body, and a movable rear monitor camera of the moving body.

In the moving body control device, the software update part may be configured to invalidate a failure detecting function provided in each of the plurality of device control units, by transmitting failure detection invalidating instruction information to a plurality of device control units via the integrated control unit, when executing the update processing for the software of at least one of the plurality of device control units.

In the moving body control device, the software update part may be configured to validate the failure detecting function provided in each of the plurality of device control units, by transmitting failure detection validating instruction information to the plurality of device control units via the integrated control unit, when the update processing for the software of the device control unit is completed.

As a second aspect for achieving the above object, a moving body control method to be executed by a computer is provided, the moving body control method including a software updating step of executing update processing for software of a device control unit provided in a moving body, a device operation state recognizing step of recognizing an operation state of an operation device controlled by the device control unit, and a software update restricting step of executing software update prohibition processing of prohibiting the software updating step from executing the update processing for the software of the device control unit, while the operation device is recognized as being in operation by the device operation state recognizing step.

As a third aspect for achieving the above object, a storage medium storing a program is provided that causes a computer to function as a software update part that executes update processing for software of a device control unit provided in a moving body, a device operation state recognition part that recognizes an operation state of an operation device controlled by the device control unit, and a software update restriction part that executes software update prohibition processing of prohibiting the software update part from executing the update processing for the software of the device control unit, while the operation device is recognized as being in operation by the device operation state recognition part.

According to the above moving body control device, moving body control method, and storage medium, it is possible to avoid that an operation of a device provided in a moving body is interrupted by update processing for software of the control device.

### BRIEF DESCRIPTION OF THE DRAWINGS

FIG. 1 is a configuration diagram of a moving body control device;

FIG. 2 is a first flowchart of software update processing of a local ECU; and

FIG. 3 is a second flowchart of the software update processing of the local ECU.

### DETAILED DESCRIPTION OF THE INVENTION

### 1. Configuration of Moving Body Control Device

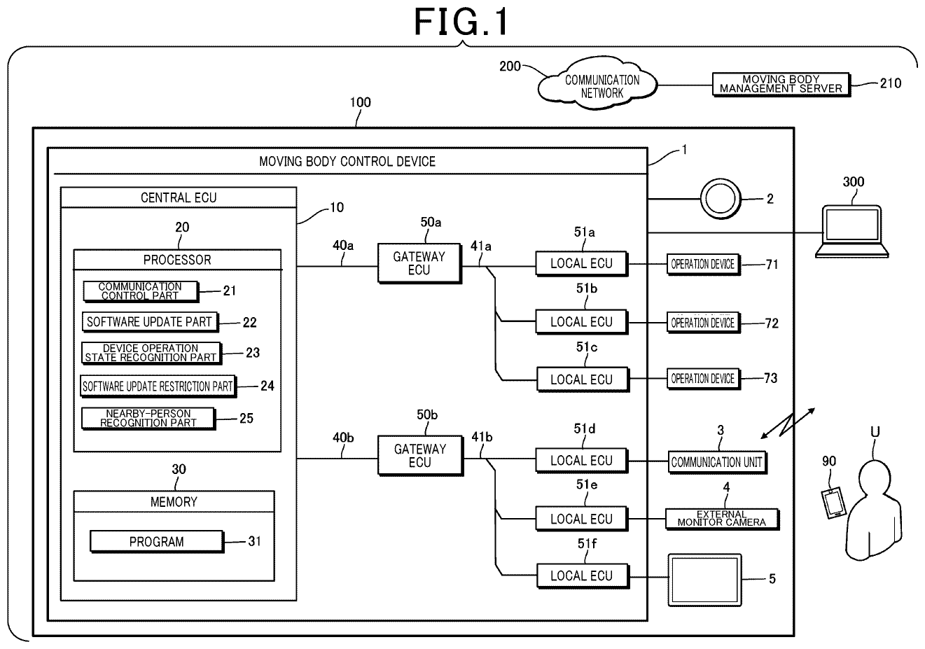

With reference to FIG. 1, a configuration of a moving body control device 1 of the present embodiment will be described. The moving body control device 1 is mounted on a moving body 100 (corresponding to a subject moving body of the present disclosure), to control an operation of the moving body 100. The moving body 100 is a vehicle, an aircraft, a ship, or the like. The moving body 100 includes a start/stop (SS) switch 2 that instructs start and stop (power ON and power OFF) of the moving body 100, a communication unit 3 (transmitter/receiver, circuit), an external monitor camera 4, and a display 5.

The communication unit 3 performs communication with a moving body management server 210 and a user terminal 90 for use by a moving body user U via a communication network 200 and performs short-range wireless communication with the user terminal 90 through Bluetooth (registered trademark), Wi-Fi (registered trademark), or the like. The external monitor camera 4 takes a photograph of surroundings of the moving body 100.

The moving body control device 1 includes a central electronic control unit (ECU) 10, gateway ECUs 50a and 50b, and local ECUs 51a to 51f. The central ECU 10 is connected to the gateway ECU 50a by a communication line 40a and is connected to the gateway ECU 50b by a communication line 40b.

The gateway ECU 50a is connected to a plurality of local ECUs 51a to 51c by a communication line 41a, and the gateway ECU 50b is connected to a plurality of local ECUs 51d to 51f by a communication line 41b. The local ECUs 51a to 51c control operations of operation devices 71 to 73 provided in the moving body 100. Examples of the operation devices 71 to 73 include an opening/closing device of a door of the moving body 100, a locking device of the door of the moving body 100, a charge lid of the moving body 100, a fuel lid of the moving body 100, an electric sliding seat of the moving body 100, an opening/closing device of a trunk of the moving body 100, an opening/closing device of a tailgate of the moving body 100, a telescopic device of an air suspension of the moving body 100, an opening/closing device of a power window of the moving body 100, an opening/closing device of a sunroof of the moving body 100, an opening/closing device of a sunshade of the moving body 100, a tilt and telescopic adjustment device of a steering wheel of the moving body 100, a movable rear monitor camera of the moving body 100, and the like. Furthermore, the local ECU 51d controls an operation of the communication unit 3, the local ECU 51e controls an operation of the external monitor camera 4, and the local ECU 51f controls an operation of the display 5.

Hereinafter, the gateway ECUs 50a and 50b are collectively referred to as a gateway ECU 50, and the local ECUs 51a to 51f are collectively referred to as a local ECU 51. The central ECU 10, the gateway ECU 50, and the local ECU 51 are control units each including a processor, memory, interface circuit, and the like. The gateway ECU 50 corresponds to an integrated control unit of the present disclosure, and the local ECU 51 corresponds to a device control unit of the present disclosure.

A plurality of local ECUs 51 connected to the gateway ECU 50 are grouped according to a function and location of a target to be controlled by the local ECU 51. FIG. 1 illustrates two gateway ECUs 50a and 50b and may include three or more gateway ECUs 50. Furthermore, the number of control targets connected by the local ECU 51 may be two or more.

The central ECU 10 executes management of the moving body 100 over the air (OTA), and in the present embodiment, description will be made as to processing of the central ECU 10 downloading an updated version of software of the local ECU 51 (software for updating) from the moving body management server 210 to update the software of the local ECU 51.

The central ECU 10 includes a processor 20, a memory 30 (storage medium), and others, and a controlling program 31 of the central ECU 10 is stored in the memory 30. The processor 20 corresponds to the computer of the present disclosure. The processor 20 reads and executes the program 31, thereby functioning as a communication control part 21, a software update part 22, a device operation state recognition part 23, a software update restriction part 24, and a nearby-person recognition part 25.

Processing executed by the software update part 22 corresponds to a software updating step in a moving body control method of the present disclosure, and processing executed by the device operation state recognition part 23 corresponds to a device operation state recognizing step in the moving body control method of the present disclosure. Processing executed by the software update restriction part 24 corresponds to a software update restricting step in the moving body control method of the present disclosure.

The communication control part 21 controls the communication with the moving body management server 210 and the user terminal 90 by the communication unit 3. The software update part 22 downloads and acquires the updated version of software of the local ECU 51 from the moving body management server 210 and executes software update processing of updating the software of the local ECU 51 from a previous version to the updated version. The updated version of software may be received and acquired from a maintenance terminal 300 connected to the moving body control device 1.

The device operation state recognition part 23 recognizes an operation state of the operation device, by receiving operation state information of the operation device controlled by the local ECU 51, via the gateway ECU 50. The software update restriction part 24 executes software update restriction processing of prohibiting the software update part 22 from updating the software of the local ECU 51, while the operation device is recognized as being in operation by the device operation state recognition part 23.

The nearby-person recognition part 25 recognizes nearby person of a person present around the moving body 100 from a photographed image of the external monitor camera 4. In addition, depending on reception intensity of radio waves by the communication unit 3, nearby person of a person possessing a terminal device may be recognized.

### 2. Software Update Processing

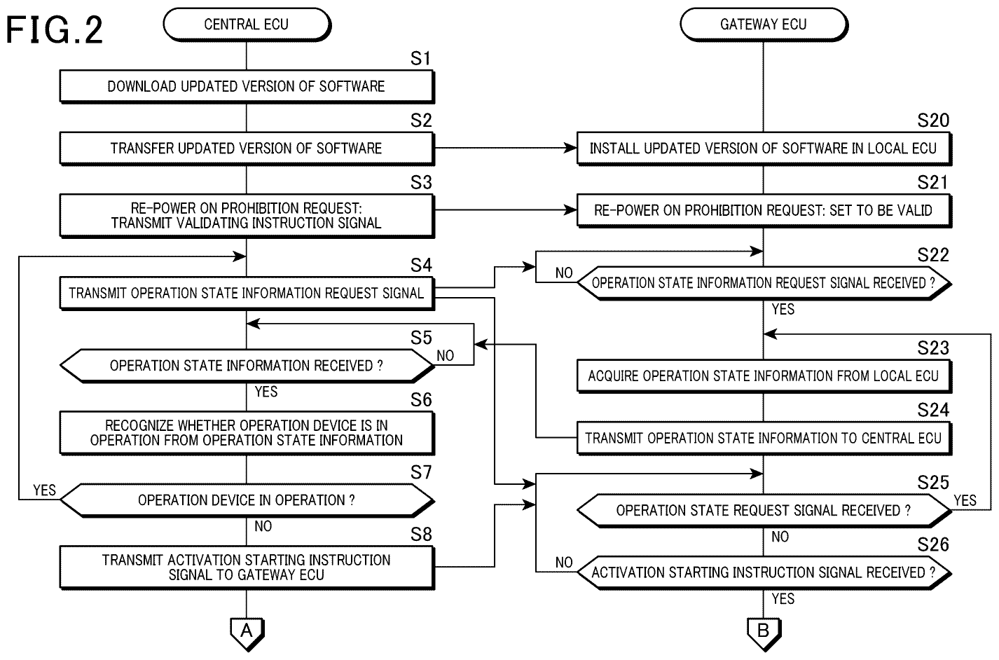

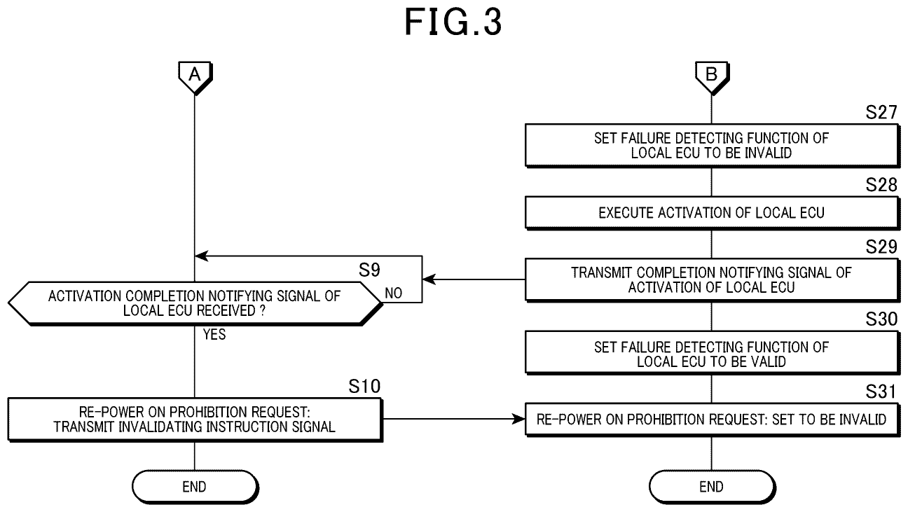

According to the flowchart shown in FIGS. 2 and 3, a procedure for the software update processing of the local ECU 51 that is executed by the moving body control device 1 will be described. When the moving body 100 is in a standby state (a state in which the SS switch 2 is operated to stop and power for the moving body 100 is turned off), the moving body control device 1 executes the processing according to the flowchart shown in FIGS. 2 and 3. The central ECU 10 updates the software of the local ECU 51 by communicating with the local ECU 51 via the gateway ECU 50.

In step S1 of FIG. 2, for the software update part 22, the communication control part 21 downloads an updated version of software of the local ECU 51 from the moving body management server 210. Subsequently, in step S2, the software update part 22 transfers the updated version of software to the gateway ECU 50. In step S20, the gateway ECU 50 transmits the updated version of software received from the central ECU 10 to the local ECU 51, to install the updated version of software in the local ECU 51.

The memory of the local ECU 51 includes a two-plane configuration, and the updated version of software is stored on a plane different from a plane on which the previous version of software in use is stored. Then, by activation processing described later, the software for use by the local ECU 51 switches from the previous version to the updated version, and the update of the software of the local ECU 51 is completed.

In step S3, the software update part 22 transmits a validating instruction signal of a re-power ON prohibition request to the gateway ECU 50, to instruct re-power ON prohibition due to a start operation of the SS switch 2. In step S21, the gateway ECU 50 transmits, to the local ECU 51, the validating instruction signal of the re-power ON prohibition request to the local ECU 51, to set the local ECU 51 to be in a re-power ON prohibition state.

In step S4, the device operation state recognition part 23 transmits, to the gateway ECU 50, an operation state request signal to request transmission of operation state information indicating a state of the operation device controlled by the local ECU 51. Upon receiving the operation state request signal in step S22, the gateway ECU 50 proceeds with processing to step S23, and receives the operation state information from the local ECU 51 by communicating with the local ECU 51. Subsequently, in step S24, the gateway ECU 50 transmits the operation state information to the central ECU 10.

In step S5, upon receiving the operation state information from the gateway ECU 50, the device operation state recognition part 23 proceeds with the processing to step S6. In step S6, the device operation state recognition part 23 recognizes whether the operation device controlled by the local ECU 51 is in operation. Subsequently, in step S7, the software update restriction part 24 proceeds with the processing to step S4 when the operation device is recognized as being in operation by the device operation state recognition part 23 and proceeds with the processing to step S8 when the operation device is recognized as being stopped by the device operation state recognition part 23.

The processing of step S7 (software update prohibition processing) prohibits the execution of activation processing in and after step S8 until the operation device controlled by the local ECU 51 is recognized as being stopped. This avoids interruption of the operation of the operation device. In step S8, the software update part 22 transmits an activation starting instruction signal to the gateway ECU 50. Upon receiving the activation starting instruction signal, the gateway ECU 50 proceeds with the processing from step S26 to step S27 of FIG. 3.

In step S27 of FIG. 3, the gateway ECU 50 sets a failure detecting function of the local ECU 51 to be invalid by communicating with the local ECU 51. Consequently, during execution of activation by the local ECU 51, it is possible to avoid that failure detection is made because control processing is interrupted by the local ECU 51 and failure detection information is output from the local ECU 51, so that need for processing by the central ECU 10 on receiving the failure detection information can be eliminated.

Subsequently, in step S28, the gateway ECU 50 executes activation of the local ECU 51, by communicating with the local ECU 51 and instructing the local ECU 51 to execute the activation. Next, in step S29, when it is recognized that the activation of the local ECU 51 is completed by communication with the local ECU 51, the gateway ECU 50 transmits a completion notifying signal of the activation to the central ECU 10.

In step S9, upon receiving the activation completion notifying signal, the software update part 22 proceeds with the processing to step S10 and transmits an invalidating instruction signal of the re-power ON prohibition request to the gateway ECU 50. In step S31, the gateway ECU 50 sets the re-power ON prohibition request of the local ECU 51 to be invalid and enables re-power ON of the local ECU 51. The software update part 22 displays, on the display 5, a screen notifying that the software has been updated, when the SS switch 2 is operated to start next time.

### 4. Other Embodiments

In the above embodiment, when completion of the operation of the operation device is recognized in step S7 of FIG. 2, the software update restriction part 24 immediately proceeds with the processing to step S8 and transmits the activation starting instruction signal to the gateway ECU 50. As another embodiment, when completion of the operation of the operation device is recognized in step S7, the software update restriction part 24 may execute at least one of first determination processing to third determination processing as follows and then transmit the activation starting instruction signal to the gateway ECU 50.

First determination processing: when completion of the operation of the operation device is recognized in step S7 and when the nearby-person recognition part 25 determines whether nearby person in the vicinity of the moving body 100 is confirmed and confirms the nearby person, the software update restriction part 24 waits until any nearby person is not recognized and proceeds with the processing to step S8. In addition, if the first determination processing is not performed, it is not necessary to provide the nearby-person recognition part 25.

Second determination processing: when the operation device starts operating after the moving body control device 1 receives the operation instruction information transmitted from the user terminal 90 in response to the operation of the user terminal 90 by the user U and when the completion of the operation of the operation device is recognized in step S7, the software update restriction part 24 transmits, to the user terminal 90, the software update confirmation information inquiring whether to execute software update, to display a software update confirmation screen on a display unit of the user terminal 90. When the software update restriction part 24 then receives software update instruction information transmitted from the user terminal 90, the software update instruction information instructing the software update, the part proceeds with the processing to step S8.

Third determination processing: when the completion of the operation of the operation device is recognized in step S7, the software update restriction part 24 receives detected information of the acceleration sensor provided in the user terminal from the user terminal 90 and determines whether the user terminal is stopped. Then, when it is recognized that the user terminal 90 is stopped, the software update part 22 proceeds with the processing to step S8, to transmit the activation starting instruction signal to the gateway ECU 50.

In the above embodiment, the software update part 22 invalidates the failure detecting function of the local ECU 51 via the gateway ECU 50 in step S27 of FIG. 3 and validates the failure detecting function of the local ECU 51 via the gateway ECU 50 in step S30. As another embodiment, processing of switching the invalidating and validating of the failure detecting function of each of a plurality of local ECUs 51 via the gateway ECU 50 may not be performed.

To facilitate the understanding of the present invention, FIG. 1 is a schematic diagram showing the configuration of the moving body control device 1 by dividing the configuration according to main processing contents, and any other types of division may be used to compose the moving body control device 1. Furthermore, processing of each component may be executed by one hardware unit or executed by a plurality of hardware units. In addition, the processing by each component shown in FIGS. 2 and 3 may be executed by one program or executed by a plurality of programs.

### 4. Configuration Supported by the Above Embodiment

The above embodiment is a specific example including configurations as follows.

(Configuration 1) A moving body control device comprising: a software update part that executes update processing for software of a device control unit provided in a moving body, a device operation state recognition part that recognizes an operation state of an operation device controlled by the device control unit, and a software update restriction part that executes software update prohibition processing of prohibiting the software update part from executing the update processing for the software of the device control unit, while the operation device is recognized as being in operation by the device operation state recognition part.

The moving body control device of Configuration 1 can avoid interruption of the operation of the operation device due to the execution of the software update processing of the device control unit when the operation device is in operation.

(Configuration 2) The moving body control device according to Configuration 1, further comprising: an integrated control unit connected to a plurality of device control units individually controlling a plurality of operation devices provided in the moving body, wherein the software update part executes update processing for software of each of the plurality of device control units via the integrated control unit, the device operation state recognition part recognizes an operation state of each of the plurality of operation devices via the integrated control unit, and the software update restriction part executes the software update prohibition processing for the plurality of device control units via the integrated control unit.

According to the moving body control device of Configuration 2, by controlling the plurality of device control units via the integrated control unit, it is possible to efficiently perform transmission of information among the software update part, the device operation state recognition part and the software update restriction part, and the plurality of device control units.

(Configuration 3) The moving body control device according to Configuration 1 or 2, further comprising: a nearby-person recognition part that recognizes a person around the moving body, wherein the software update restriction part ends the software update prohibition processing, and allows the software update part to execute the update processing for the software of the device control unit, when the device operation state recognition part recognizes that the operation of the operation device has ended and the person is not recognized by the nearby-person recognition part during the execution of the software update prohibition processing.

According to the moving body control device of Configuration 3, it is possible to maintain a state in which use of the operation device is possible, by continuing prohibition of update of the software of the device control unit, when the nearby person such as the user of the moving body is recognized.

(Configuration 4) The moving body control device according to any one of Configurations 1 to 3, further comprising: a communication control part that performs communication with a user terminal for use by a user of the moving body, wherein the device control unit starts operating the operation device upon the communication control part receiving operation instruction information of the operation device that is transmitted from the user terminal, and after starting the software update prohibition processing when the device control unit starts operating the operation device on receiving the operation instruction information and in response to the device operation state recognition part recognizing that the operation device is in operation, and when the device operation state recognition part recognizes completion of the operation of the operation device, the software update restriction part: causes the communication control part to transmit, to the user terminal, software update confirmation information inquiring whether to execute the update processing for the software of the device control unit; and upon the communication control part receiving software update instruction information transmitted from the user terminal, ends the software update prohibition processing to allow the software update part to execute the update processing for the software of the device control unit, the software update instruction information instructing the execution of the update processing for the software of the device control unit.

According to the moving body control device of Configuration 4, it is possible to avoid that the operation device cannot be used against user's intention due to the execution of the update of the software of the device control unit, by inquiring whether to update the software via the user terminal, when the user uses the user terminal to operate the operation device of the moving body.

(Configuration 5) The moving body control device according to any one of Configurations 1 to 4, further comprising: a communication control part that performs communication with a user terminal for use by a user of the moving body, wherein the device control unit starts operating the operation device upon the communication control part receiving operation instruction information of the operation device that is transmitted from the user terminal, and after starting the software update prohibition processing when the device control unit starts operating the operation device on receiving the operation instruction information and in response to the device operation state recognition part recognizing that the operation device is in operation, and when the device operation state recognition part recognizes completion of the operation of the operation device, the software update restriction part: receives, via the communication control part, detected information of an acceleration sensor provided in the moving body, to recognize whether the user terminal is stopped based on the detected information, the detected information being transmitted from the user terminal; and when it is recognized that the user terminal is stopped, ends the software update prohibition processing to allow the software update part to execute the update processing for the software of the device control unit.

According to the moving body control device of Configuration 5, it is possible to execute the update processing for the software of the device control unit, when it is presumed that the user has finished using the operation device because the user terminal is stopped.

(Configuration 6) The moving body control device according to any one of Configurations 1 to 5, wherein the operating device is any one of an opening/closing device of a door of the moving body, a locking device of the door of the moving body, a charge lid of the moving body, a fuel lid of the moving body, an electric sliding seat of the moving body, an opening/closing device of a trunk of the moving body, an opening/closing device of a tailgate of the moving body, a telescopic device of an air suspension of the moving body, an opening/closing device of a power window of the moving body, an opening/closing device of a sunroof of the moving body, an opening/closing device of a sunshade of the moving body, a tilt and telescopic adjustment device of a steering wheel of the moving body, and a movable rear monitor camera of the moving body.

According to the moving body control device of Configuration 6, it is possible to avoid that the user feels inconvenient due to a stop in the middle of an operation of the opening/closing device of the door of the moving body, the locking device of the door of the moving body, the charge lid of the moving body, the fuel lid of the moving body, the electric sliding seat of the moving body, the opening/closing device of the trunk of the moving body, the opening/closing device of the tailgate of the moving body, the telescopic device of the air suspension of the moving body, the opening/closing device of the power window of the moving body, the opening/closing device of the sunroof of the moving body, the opening/closing device of the sunshade of the moving body, the tilt and telescopic adjustment device of the steering wheel of the moving body, or the movable rear monitor camera of the moving body.

(Configuration 7) The moving body control device according to any one of Configurations 1 to 6, wherein the software update part invalidates a failure detecting function provided in each of the plurality of device control units, by transmitting failure detection invalidating instruction information to a plurality of device control units via the integrated control unit, when executing the update processing for the software of at least one of the plurality of device control units.

According to the moving body control device of Configuration 7, it is possible to avoid that a state different from a normal state is determined as a failure as the device control unit executes the software update processing and that the failure detection information is output from the device control unit.

(Configuration 8) The moving body control device according to Configuration 7, wherein the software update part validates the failure detecting function provided in each of the plurality of device control units, by transmitting failure detection validating instruction information to the plurality of device control units via the integrated control unit, when the update processing for the software of the device control unit is completed.

According to the moving body control device of Configuration 8, the failure detecting function of the device control unit can be validated at a time when the update of the software of the device control unit is completed.

(Configuration 9) A moving body control method to be executed by a computer, including a software updating step of executing update processing for software of a device control unit provided in a moving body, a device operation state recognizing step of recognizing an operation state of an operation device controlled by the device control unit, and a software update restricting step of executing software update prohibition processing of prohibiting the software updating step from executing the update processing for the software of the device control unit, while the operation device is recognized as being in operation by the operation state recognizing step.

By executing the moving body control method of Configuration 9 with the computer, the same operations and effects as in the moving body control device of Configuration 1 can be obtained.

(Configuration 10) A storage medium storing a program causing a computer to function as a software update part that executes update processing for software of a device control unit provided in a moving body, a device operation state recognition part that recognizes an operation state of an operation device controlled by the device control unit, and a software update restriction part that executes software update prohibition processing of prohibiting the software update part from executing the update processing for the software of the device control unit, while the operation device is recognized as being in operation by the device operation state recognition part.

By executing the program of Configuration 10 with the computer, a configuration of the moving body control device of Configuration 1 can be implemented.

### Reference Signs List

1 . . . moving body control device, 2. . . . SS switch, 3 . . . communication unit, 4 . . . external monitor camera, 5 . . . display, 10 . . . central ECU, 20 . . . processor, 21 . . . communication control part, 22 . . . software update part, 23 . . . device operation state recognition part, 24 . . . software update restriction part, 25 . . . nearby-person recognition part, 30 . . . memory, 31 . . . program, 50 (50a, 50b). gateway ECU (integrated control unit), 51 (51a to 51f) . . . local ECU (device control unit), 71 to 73 . . . operation device, 90 . . . user terminal, 100 . . . moving body, 200 . . . communication network, 210 . . . moving body management server, 300 . . . maintenance terminal, U . . . user.

1. A moving body control device comprising:
a software update part that executes update processing for software of a device control unit provided in a moving body,
a device operation state recognition part that recognizes an operation state of an operation device controlled by the device control unit, and
a software update restriction part that executes software update prohibition processing of prohibiting the software update part from executing the update processing for the software of the device control unit, while the operation device is recognized as being in operation by the device operation state recognition part.

2. The moving body control device according to claim 1, further comprising:
an integrated control unit connected to a plurality of device control units individually controlling a plurality of operation devices provided in the moving body, wherein the software update part executes update processing for software of each of the plurality of device control units via the integrated control unit,
the device operation state recognition part recognizes an operation state of each of the plurality of operation devices via the integrated control unit, and
the software update restriction part executes the software update prohibition processing for the plurality of device control units via the integrated control unit.

3. The moving body control device according to claim 1, further comprising:
a nearby-person recognition part that recognizes a person around the moving body, wherein the software update restriction part ends the software update prohibition processing, and allows the software update part to execute the update processing for the software of the device control unit, when the device operation state recognition part recognizes that the operation of the operation device has ended and the person is not recognized by the nearby-person recognition part during the execution of the software update prohibition processing.

4. The moving body control device according to claim 1, further comprising:
a communication control part that performs communication with a user terminal for use by a user of the moving body, wherein the device control unit starts operating the operation device upon the communication control part receiving operation instruction information of the operation device that is transmitted from the user terminal, and
after starting the software update prohibition processing when the device control unit starts operating the operation device on receiving the operation instruction information and in response to the device operation state recognition part recognizing that the operation device is in operation, and when the device operation state recognition part recognizes completion of the operation of the operation device, the software update restriction part: causes the communication control part to transmit, to the user terminal, software update confirmation information inquiring whether to execute the update processing for the software of the device control unit; and upon the communication control part receiving software update instruction information transmitted from the user terminal, ends the software update prohibition processing to allow the software update part to execute the update processing for the software of the device control unit, the software update instruction information instructing the execution of the update processing for the software of the device control unit.

5. The moving body control device according to claim 1, further comprising:
a communication control part that performs communication with a user terminal for use by a user of the moving body, wherein the device control unit starts operating the operation device upon the communication control part receiving operation instruction information of the operation device that is transmitted from the user terminal, and
after starting the software update prohibition processing when the device control unit starts operating the operation device on receiving the operation instruction information and in response to the device operation state recognition part recognizing that the operation device is in operation, and when the device operation state recognition part recognizes completion of the operation of the operation device, the software update restriction part: receives, via the communication control part, detected information of an acceleration sensor provided in the moving body, to recognize whether the user terminal is stopped based on the detected information, the detected information being transmitted from the user terminal; and when it is recognized that the user terminal is stopped, ends the software update prohibition processing to allow the software update part to execute the update processing for the software of the device control unit.

6. The moving body control device according to claim 1, wherein the operation device is any one of an opening/closing device of a door of the moving body, a locking device of the door of the moving body, a charge lid of the moving body, a fuel lid of the moving body, an electric sliding seat of the moving body, an opening/closing device of a trunk of the moving body, an opening/closing device of a tailgate of the moving body, a telescopic device of an air suspension of the moving body, an opening/closing device of a power window of the moving body, an opening/closing device of a sunroof of the moving body, an opening/closing device of a sunshade of the moving body, a tilt and telescopic adjustment device of a steering wheel of the moving body, and a movable rear monitor camera of the moving body.

7. The moving body control device according to claim 2, wherein the software update part invalidates a failure detecting function provided in each of the plurality of device control units, by transmitting failure detection invalidating instruction information to the plurality of device control units via the integrated control unit, when executing the update processing for the software of at least one of the plurality of device control units.

8. The moving body control device according to claim 7, wherein the software update part validates the failure detecting function provided in each of the plurality of device control units, by transmitting failure detection validating instruction information to the plurality of device control units via the integrated control unit, when the update processing for the software of the device control unit is completed.

9. A moving body control method to be executed by a computer, including:
a software updating step of executing update processing for software of a device control unit provided in a moving body,
a device operation state recognizing step of recognizing an operation state of an operation device controlled by the device control unit, and
a software update restricting step of executing software update prohibition processing of prohibiting the software updating step from executing the update processing for the software of the device control unit, while the operation device is recognized as being in operation by the operation state recognizing step.

10. A non-transitory computer readable storage medium storing a program causing a computer to function as:
a software update part that executes update processing for software of a device control unit provided in a moving body,
a device operation state recognition part that recognizes an operation state of an operation device controlled by the device control unit, and
a software update restriction part that executes software update prohibition processing of prohibiting the software update part from executing the update processing for the software of the device control unit, while the operation device is recognized as being in operation by the device operation state recognition part.
